(19) United States
(12) Patent Application Publication
(10) Pub. No.: US 2014/0255660 A1
(43) Pub. Date: Sep. 11, 2014

(54) PROTECTIVE MATERIAL AND USE OF SAME

(71) Applicants: Andrei Patrushin, Kouvola (FI); Saara Eskola, Kouvola (FI); Sami-Seppo Ovaska, Lappeenranta (FI); Sanna Haavisto, Kotka (FI); Heidi Lehtinen, Kotka (FI); Katriina Mielonen, Lappeenranta (FI)

(72) Inventors: Andrei Patrushin, Kouvola (FI); Saara Eskola, Kouvola (FI); Sami-Seppo Ovaska, Lappeenranta (FI); Sanna Haavisto, Kotka (FI); Heidi Lehtinen, Kotka (FI); Katriina Mielonen, Lappeenranta (FI)

(73) Assignee: KYMENLAAKSON AMMATTIKORKEAKOULU OY, Kotka (FI)

(21) Appl. No.: 14/343,228

(22) PCT Filed: Sep. 7, 2012
(86) PCT No.: PCT/FI2012/050869

§ 371 Date: Apr. 29, 2014

(30) Foreign Application Priority Data
Sep. 7, 2011 (FI) 20115880

(51) Int. Cl. B32B 3/08; B32B 5/02; B32B 29/00

(52) U.S. Cl. CPC B32B 3/08; B32B 29/005; B32B 5/024; B32B 5/022; B32B 2262/0253
USPC 428/193

(57) ABSTRACT

The invention relates to a protective material (1) which can be used in the applications of public healthcare, rescue services, transportation of patients and nursing institutions. According to the invention, the protective material is an elongated plate-type material, the protective material being in the form of a layered structure including at least a body layer (2) with at least a core layer (3) formed from a network-reinforced polymeric material, and at least one absorbent fiber-based layer (4) which is provided to the upper surface of the body layer (2) and at least partially connected to the upper surface of the body layer, and edge reinforcements (9) provided to the longitudinal outer edges of the body layer in the protective material and connected to the upper surface of the body layer (2). In addition, the invention relates to the use of the protective material.

### FIELD OF THE INVENTION

The invention relates to a protective material as defined in the preamble of claim 1 which can be used for example in the applications of public healthcare, rescue services, transportation of patients and nursing institutions, and to the use of the protective material as defined in the preamble of claim 15.

### BACKGROUND OF THE INVENTION

Known from the prior art are different protective materials made of plastic and fabric to be used as protective textiles, e.g. as bed covers, in the field of public healthcare, e.g. in hospitals, ambulances and other similar applications. Common to the protective materials used is that they must be hygienic and absorbent.

Fabric-based protective materials are always washed up after use so as to be once again clean for the next use. What presents problems is the massive logistics arrangements for delivery to washing as well as the expenses incurred by transportation and washing. In addition, the purchase price of fabric-based protective materials is relatively high.

The problem in the known protective materials including plastic is their insufficient absorbency.

The problem in many known protective materials is that the bacteria pass through the material or reside in the material and thus spread easily to the environment from the material. Oftentimes the protective materials cannot be disinfected with sufficient specificity and sufficiently strong disinfectants cannot be used. In addition, the washable protective materials cannot be washed at sufficiently high temperatures e.g. to remove the superbacteria. Spreading of infections is a problem and prevention and consequences of spreading of the infections incur considerable expenses.

In addition, known from the prior art are different transfer materials e.g. for transferring a person from one base to another.

In addition, known from the prior art are different layered materials combining plastic-based layers with different materials for example to coat the materials.

### OBJECTIVE OF THE INVENTION

The objective of the invention is to disclose a new type of hygienic, absorbent and infection-free protective and transfer material. Another objective of the invention is to disclose a versatile protective and transfer material designed for protection and transfers.

### SUMMARY OF THE INVENTION

The protective material and the use of same according to the invention are characterized by what is disclosed in the claims.

The invention is based on a protective material which can be used for example in the applications of public healthcare, rescue services, transportation of patients and nursing institutions. According to the invention, the protective material is an elongated plate-type material, the protective material being in the form of a layered structure including at least a body layer with at least a core layer formed from a network-reinforced polymeric material, and at least one absorbent fiber-based layer provided to the upper surface of the body layer and at least partially connected to the upper surface of the body layer, and edge reinforcements provided to the longitudinal outer edges of the body layer in the protective material, preferably for a predetermined width, and connected to the upper surface of the body layer. Preferably, the fiber-based layer is connected only partially to the upper surface of the body layer, and preferably only at the longitudinal edges of the fiber-based layer.

The basis of the invention is specifically an absorbent, fluid-impermeable and hygienic disposable protective and transfer material, the use of which is easy and effortless and allows one to prevent spreading of infections.

A protective material refers in this connection to any protective and transfer material and/or protective and transfer product applicable for use to protect different bases and to transfer, e.g. to transfer a patient or a victim, from one base to another. A protective material refers in this connection to any plate-type material having the layered structure according to the invention and being both absorbent and fluid-impermeable. Preferably, the protective material is web-type or sheet-type with a desired width and a predetermined length. The protective material can be used in different applications of public healthcare, such as in hospitals and healthcare centers, nursing institutions, elderly care institutions, spas, patient transportations or similar applications.

In one embodiment of the invention, the thickness of the protective material is less than 1.5 mm, in one embodiment less than 1 mm, and in one embodiment from 0.1 mm to 1.5 mm. In one embodiment, the protective material has a total width of from 50 to 110 cm. Preferably, the length of the protective material may vary according to the application. The protective material may be provided as a roll from which a piece of protective material of a suitable length is cut according to the purpose of use. In one embodiment, the protective material is provided in the form of a cut-to-size elongated sheet product. In one embodiment, the length of the protective material product is from 160 to 230 cm.

In one embodiment of the invention, the network-reinforced polymeric material includes a network reinforcement layer and a polymeric film connected, e.g. by extrudation, lamination or other suitable manner, to one another to constitute an integrated network-reinforced polymeric material. In one embodiment, the network reinforcement layer is formed from polypropylene, polyethylene or their derivatives or their combinations. In one embodiment, the polymeric film is formed from polyethylene, such as HD polyethylene, LD polyethylene, another polyolefin, such as polypropylene, or their derivatives or their combinations.

In one embodiment, the network reinforcement layer and/or the polymeric film includes HD polyethylene, LD polyethylene, polypropylene, another suitable polyolefin or another polymer suitable for the purpose of use or combinations thereof. In one embodiment, the network reinforcement layer and/or the polymeric film may include any polymer suitable for the purpose of use. In one embodiment, the network reinforcement layer and/or the polymeric film includes a biopolymer suitable for the purpose of use, e.g. a polylactic acid (PLA). In one embodiment, the network reinforcement layer and/or the polymeric film is formed at least partially from recycled plastic. In addition, the network reinforcement layer and/or the polymeric film may include fibrous components and/or suitable additives, e.g. additives improving the properties of the polymeric material.

In one embodiment, the network reinforcement layer is formed from a polypropylene network and the polymeric film is formed from polyethylene, and the network reinforcement layer and the polymeric film are connected to one another by extrudation to constitute an integrated network-reinforced polymeric material. In one embodiment, the network reinforcement layer and the polymeric film are formed from polyethylene-based materials which may include different polyethylenes.

In one embodiment, the network-reinforced polymeric material has a surface density of from 100 to 300 g/m².

An essential feature in the network-reinforced polymeric material is a good strength and durability.

In one embodiment, the body layer includes second polymeric material layers laminated on both sides of the core layer. In one embodiment, the body layer includes one layer of the second polymeric material, in one embodiment laminated to the lower surface of the core layer and in another embodiment to the upper surface of the core layer, i.e. between the core layer and the fiber-based layer.

In one embodiment, the lower surface of the body layer is provided with a bottom layer. In one embodiment, the body layer includes a bottom layer provided under the core layer to reduce friction, preferably to decrease friction on the lower surface of the network-reinforced polymeric material. The bottom layer may be a pile-type layer, e.g. a viscose pile type layer. In an alternative embodiment, the bottom layer may be formed from a suitable material without a pile-type surface.

In one embodiment of the invention, the bottom layer is formed from a nonwoven material. In one embodiment, the nonwoven material is formed from polyethylene, such as LD polyethylene, HD polyethylene or a combination thereof, another polyolefin, such as polypropylene or their derivatives or their combinations. In one embodiment, the nonwoven material is formed from polypropylene. In one embodiment, the bottom layer is formed from the second polymeric material.

In one embodiment, the second polymeric material includes LD polyethylene, HD polyethylene, another suitable polyolefin or another polymer suitable for the purpose of use or combinations thereof. In one embodiment, the second polymeric material may include any polymer suitable for the purpose of use. In one embodiment, the second polymeric material is mainly formed from LD polyethylene. In one embodiment, the second polymeric material includes a biopolymer suitable for the purpose of use, e.g. PLA. In one embodiment, the second polymeric material is formed at least partially from recycled plastic. In addition, the second polymeric material may include fibrous components and/or suitable additives, e.g. additives improving the properties of the polymeric material.

In one embodiment, the bottom layer is formed from a material with a surface density of less than 100 g/m², preferably less than 60 g/m² and more preferably from 40 to 60 g/m².

Preferably, the edge reinforcement is a continuous strip on the outer edge of the protective material and the body layer thereof. Alternatively, the edge reinforcement may be provided non-continuously to the outer edges. When the edge reinforcement is provided to the edge of the body layer as a continuous strip, it may be provided with a handle or handles at any site. In addition, a continuous strip is easy to make production- and cost-effectively.

Preferably, the edge reinforcement is provided to the outer edge of the upper surface in the body layer for a desired width to reinforce the edge of the protective material. Preferably, the edge reinforcement is provided specifically where strength is needed. The edge reinforcement and the fiber-based layer may be provided as partially to overlap one another at their longitudinal edges. This provides an orderly appearance and the body layer will not be visible when viewing the protective material from the top. Alternatively, the edge reinforcement and the fiber-based layer are provided adjacently in such a way as not to overlap with one another. The edge reinforcement and the fiber-based layer may be provided with one another in a butt joint.

In one embodiment of the invention, the edge reinforcement is formed from a woven material. In one embodiment, the edge reinforcement is formed from a woven fabric material which is preferably cross-woven. The woven material may include polypropylene, polyethylene or combinations thereof. In one embodiment, the edge reinforcement is formed from cross-woven polypropylene. The essential feature in the edge reinforcement is a good shear strength, a good tearing strength and/or a good durability. In one embodiment, the edge reinforcement is provided in a different color from the rest of the parts of the protective material, in order to be easily and quickly distinguishable, also in the dark.

The edge reinforcement can be connected to the upper surface of the body layer by a connection method known per se, e.g. by melting, laminating or gluing.

In one embodiment of the invention, the fiber-based layer is formed from a paper-based material. In one embodiment, the fiber-based layer is formed from a paper-based material having a surface density of approximately from 60 to 150 g/m², more preferably from 80 to 120 g/m².

The fiber-based layer can be formed using any paper-based material known per se. Paper refers in this connection to any paper formed from a fiber-based raw material and/or recycled raw material.

In one embodiment of the invention, the fiber-based layer is formed from air-laid paper. In this connection air-laid paper refers to a textile-like material or to a nonwoven fabric type material. The air-laid paper may be formed from fluff pulp. The raw material used may be long-fibered softwood pulp. Preferably, the air-laid paper is very porous, yet strong at the same time.

In one embodiment, the fiber-based layer may be formed from fluff pulp and products and product derivatives formed therefrom.

In one embodiment, the width of the fiber-based layer is smaller than the width of the body layer.

Preferably, the purpose of the fiber-based layer is to serve as an absorbent layer and absorb fluids and secretions and thereby preferably also bacteria. In addition, the purpose of the fiber-based layer is to give softness to the material.

In one embodiment, the fiber-based layer includes suitable additives to improve its properties, e.g. absorbency. In one embodiment, the fiber-based layer includes an absorbing agent. The absorbing agents, i.e. absorbents, can be selected from any absorbents suitable for the purpose of use, e.g. fluid-binding chemicals such as fluid-binding paper chemicals. In one embodiment, bio-based absorbents can be used. In one embodiment, superabsorbents can be used. One preferred superabsorbent consists of a cross-linked acrylamide which is a copolymer of acrylic acid and of a potassium salt. Other superabsorbents may be carboxymethyl cellulose, a derivative of carboxymethyl cellulose, or similar compounds. The absorbents can be provided to the material of the fiber-based layer during the manufacturing stage thereof and/or by absorbing to the finished material of the fiber-based layer and/or to the surface of the fiber-based layer. In one embodiment, the absorbents are provided on the edge areas of the protective material, particularly in an embodiment where the protective material is used as a transfer base.

In one embodiment, absorbency-improving agents, e.g. surfactants, are used as additive in the protective material.

In one embodiment of the invention, the protective material includes at least two fiber-based layers. In one embodiment, the fiber-based layers are provided substantially one above the other. In one embodiment, absorbents are provided between the fiber-based layers.

In one embodiment, the fiber-based layer is only connected at the longitudinal outer edges, for a desired width, to the body layer. In one embodiment, the connection is made by gluing, e.g. by means of stripes of adhesive, or by laminating or heat sealing. It has been discovered that if the fiber-based layer is fastened to the body layer over the entire area, the absorbency may be significantly reduced, particularly with air-laid paper.

In one embodiment of the invention, the protective material includes a top layer provided to the upper surface of the fiber-based layer or the upper-most fiber-based layer. Preferably, the purpose of the top layer is to provide a comfortable-feeling upper-most layer. In a preferred embodiment, the top layer is formed from a material feeling dry to the patient even when wet. In one embodiment, the width of the top layer is smaller than the width of the body layer.

In one embodiment, the top layer is formed from a third polymeric material. In one embodiment, the third polymeric material is selected from the group of polypropylene, polyethylene terephthalate (PET), another suitable polyolefin and another polymer suitable for the purpose of use and combinations thereof. Also other polymeric materials suitable for the purpose of use can be used. In one embodiment, the third polymeric material includes a biopolymer suitable for the purpose of use, e.g. PLA. In one embodiment, the third polymeric material is formed at least partially from recycled plastic. The third polymeric material may include suitable additives and auxiliaries.

In one embodiment, the top layer is formed from a textile-type material suitable for the purpose of use.

In one embodiment, the top layer is formed from a nonwoven material, referring to a non-knitted material at this point. The nonwoven may be a fibrous fabric material resembling a fabric. The nonwoven may be a non-knitted material formed from polymers.

In one embodiment, the top layer includes the third polymeric material and a nonwoven material. In one embodiment, the nonwoven material is treated with the third polymeric material.

In one embodiment, the fiber-based layer is fastened to another layer, e.g. the body layer, the second fiber-based layer and/or the top layer, by means of heat. In one embodiment of the invention, the fiber-based layer is fastened to another layer, e.g. the body layer, the second fiber-based layer and/or the top layer, by heat sealing. In one embodiment, the fiber-based layer is fastened to another layer, e.g. the body layer, the second fiber-based layer and/or the top layer, by gluing.

The protective material can be formed by manners known per se. During the manufacture, different material layers are run from rolls and connected to one another in a suitable manner, e.g. by gluing, laminating or heat sealing, in the longitudinal direction and the resulting product is rolled up. In one embodiment, the protective material is formed in a manner known per se in such a way that the bottom layer is laminated to the lower surface of the core layer in the body layer, the upper surface of the body layer is provided with the edge reinforcements and the fiber-based layer, and the upper surface of the fiber-based layer may be provided with the top layer, and the fiber-based layer is fastened at the edges to the body layer by gluing. The resulting roll can be formed into a product in such a way as to cut out a sheet of a suitable size, e.g. 2.1 m. Then, the desired cutting, incision and punching steps are carried out. And finally, any possible sheeting, folding, cutting and/or packing steps are carried out.

In one embodiment, the protective material is provided in a size and shape compatible with the application. In one embodiment, the protective material is provided in the form of a roll from which a suitably sized piece of protective material can be cut out.

In one embodiment, the edge of the protective material is provided with handgrips, such as carrying handles, for example for lifting. In one embodiment, the handgrips are provided with a distinctive color either entirely or partially in order to be distinguished more easily and quickly. In one embodiment, the distinctive color includes a fluorescent agent so as to be visible even in the dark.

In one embodiment of the invention, the protective material includes handgrips provided in connection with the edge reinforcements by making openings to the area of the edge reinforcement to provide the handgrips or at least one opening to provide at least one handgrip. The handgrips are positioned in the area of the edge reinforcement and preferably in the middle of the edge reinforcement in the longitudinal direction. The handgrips are made by punching, incising or cutting in the area of the edge reinforcement in the protective material. The opening may be an incision, a cut-out opening, a shaped opening or a combination thereof. The opening may have rounded corners, or the opening may be angular. If desired, stiffeners, carrying means or similar attachments can be provided through the openings. Preferably, each edge reinforcement includes more than one opening, which openings are evenly spaced relative to one another. In a preferred embodiment, the openings of two edge reinforcements positioned at both edges of the body layer are provided in aligned positions in the longitudinal direction.

In one embodiment, the protective material is provided with safety belt covers, e.g. to protect the safety belts in transportation means. In one embodiment, the safety belt covers are formed from a separate material layer. In one embodiment, the safety belt cover is formed in two parts in the longitudinal direction of the base in such a way that the parts are fastened at their one longitudinal edge close to the outer edges of the base and the free longitudinal edge of the parts is folded to the center of the base. This way, the safety belt cover can be open from the centerline of the base outwards, and the parts thereof can be raised to protect the safety belts.

In one embodiment of the invention, the protective material according to any of the above descriptions, such as a protective material product, is used in the applications of public healthcare, rescue services, transportation of patients and/or nursing institutions. In one embodiment, the protective material is used as a cover for a base, e.g. beds, stretchers, operating room tables, examination tables, treatment tables, wheelchairs, transportation means and the like. In one embodiment, the protective material is used as a transfer base to transfer or lift a patient. In one embodiment, the protective material can be used as a product in a first-aid kit.

The invention provides a hygienic and infection-safe protective material which can be disposed of right after use. By virtue of the invention, spreading of the infections can be prevented. The protective material according to the invention has a good absorbency relative to different fluids as well as bacteria. In addition, the tensile strength and the lifting strength of the protective material according to the invention are good, so the protective material is durable. In addition, the protective material is light. In addition, the protective material according to the invention is easy to be disposed of. The protective material waste can be utilized in a waste-to-energy process, for example by burning.

By virtue of the invention, a protective material suitable for any application is provided with affordable manufacturing and purchasing expenses. The protective material according to the invention is easy to transport e.g. to crisis areas and use therein. In addition, the protective material according to the invention facilitates and expedites working in emergency care. The protective material is also easy to store and has a good shelf life.

When using the protective material according to the invention, there is no need to attend to any laundry logistics.

By the invention, a protective material that can be easily and affordably manufactured on an industrial scale is achieved for many different purposes of use. In addition, the protective material according to the invention has good use comfort properties.

### LIST OF FIGURES

FIG. 1 illustrates one structure of the protective material according to the invention as a cross-sectional view,

FIG. 2 illustrates a protective material product corresponding to FIG. 1, and

FIG. 3 illustrates another structure of the protective material according to the invention as a cross-sectional view.

### DETAILED DESCRIPTION OF THE INVENTION

In the following section, the invention will be described by means of a detailed exemplary embodiment with reference to the accompanying figures.

### EXAMPLE 1

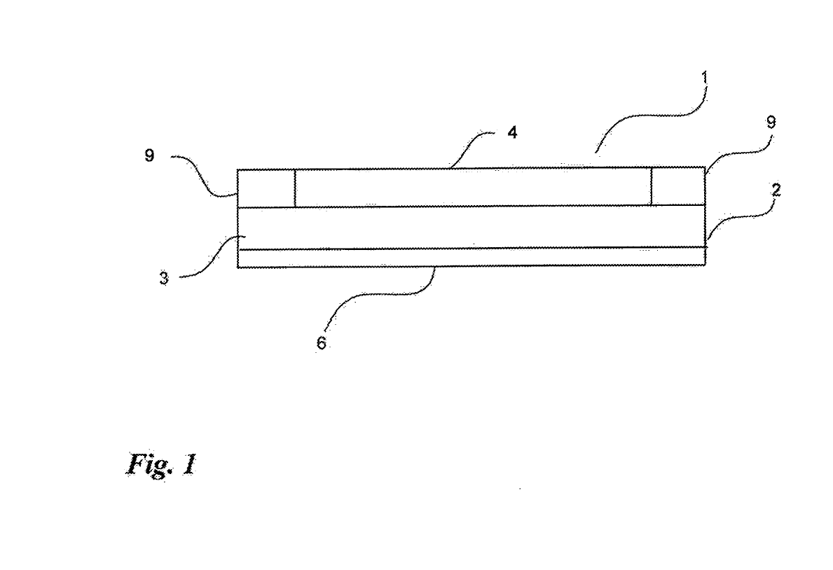

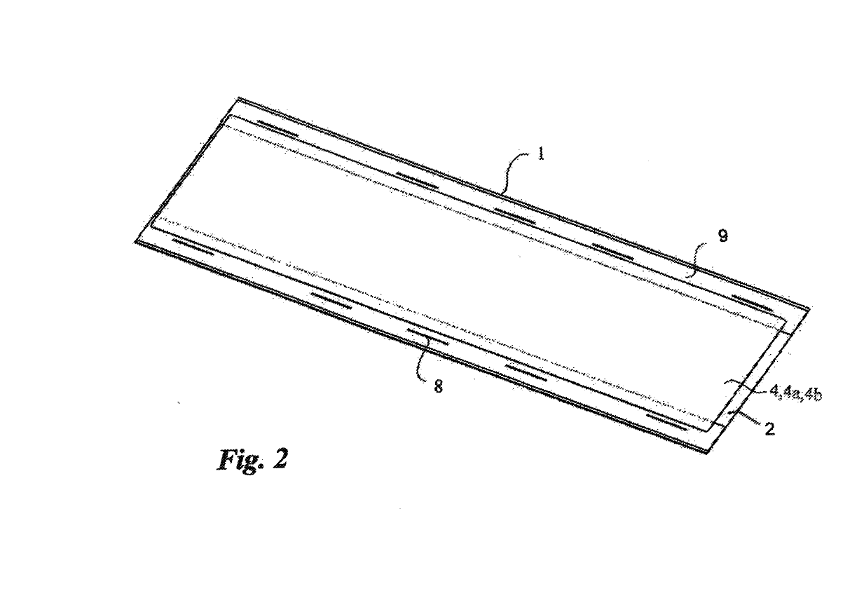

A protective material 1 according to FIGS. 1 and 2 is disclosed, having a length of approximately 210 cm and a width of approximately 95 cm. The protective material according to the figures has been tested in use. The protective material according to the figures can be used as a protective sheet and also as a transfer base.

The protective material 1 is an elongated plate-type material. The protective material is in the form of a layered structure including a body layer 2 having a core layer 3 formed from a network-reinforced polymeric material, and an absorbent fiber-based layer 4. The fiber-based layer 4 is connected to the upper surface of the body layer 2 by gluing at the outer edges in such a way as to be disconnected over the middle part from the body layer. In addition, the protective material includes edge reinforcements 9 which are provided to the longitudinal outer edges of the body layer 2 in the protective material and connected to the upper surface of the body layer by lamination. The lower surface of the network-reinforced polymeric material is provided with a bottom layer 6 to reduce friction. The network-reinforced polymeric material includes a polypropylene network and a polyethylene film joined to one another to constitute an integrated material by extrudation. The edge reinforcements are formed from a woven fabric material which includes cross-woven polypropylene. The fiber-based layer is air-laid paper. The bottom layer is formed from a polypropylene-based nonwoven material. The different layers are formed from light materials with the surface density of the body layer being approximately 150 to 200 g/m² and the surface density of the air-laid paper being approximately 100 g/m².

The protective material further includes handgrips 8 provided in connection with the edge reinforcements 9 by making, to the middle part area of the edge reinforcement, incisions to provide the handgrips 8. Incisions are provided at even distances over the entire length of the edge reinforcement and in the same positions in each edge reinforcement.

In the usage test, it was discovered that the protective material according to the invention works well both as an absorbent and as a protective material. In addition, the carrying capacity of the protective material was found to be good.

### EXAMPLE 2

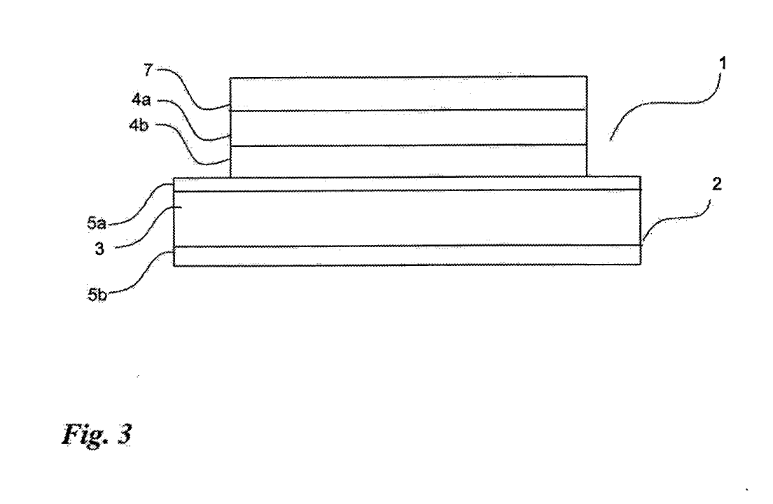

A protective material 1 according to FIG. 3 is disclosed, having a length of approximately 200 cm and a width of approximately 95 cm. The protective material according to the figure has been tested in use. The protective material according to the figure can be used as a protective sheet and also as a transfer base.

The protective material 1 comprises cross-woven HD polyethylene as a core layer 3 with LD polyethylene layers 5a,5b laminated on both sides thereof to form a body layer 2. This provides a fluid-proof body layer 2. The tensile strength of the body layer in this embodiment is approximately 600N/50 mm. The body layer has a width of approximately 95 cm and a surface density of approximately 150 g/m².

The upper surface of the body layer 2 is provided with two paper-based absorbent layers 4a,4b with superabsorbents provided therebetween. The paper-based layers 4a,4b are fastened by hot adhesive, and in one embodiment by heat sealing, to the upper surface of the body layer. The paper-based layers are formed from 80 g/m² air-laid paper which has an absorbency (water) of approximately 500 g/100 g. The paper-based layer has a width of approximately 54 cm.

The upper surface of the paper-based layers 4a,4b is provided with a 20 g/m² top layer 7 including polypropylene and a thermobonded nonwoven fibrous material. The width of the top layer 7 is approximately 55 cm. The top layer is connected to the surface of the paper-based layers by hot adhesive, and in one embodiment by heat sealing.

The use of absorbents to increase the absorbency of the protective material has also been tested herein. One preferred superabsorbent consists of a cross-linked acrylamide which is a copolymer of acrylic acid and of a potassium salt. In the tests, it was discovered that the particle size of the absorbents does matter. It was discovered that a small particle absorbs water faster than a large particle. On the other hand, a larger particle size allows one to reach slower water absorbency and better water retention. Thus, it is very preferred to use a mixture of several different particle sizes as the absorbent so as to achieve both a sufficient water retention and fast fluid absorption.

Incisions are provided to each edge of the protective material 1, preferably to the edges of the body structure 2, for handgrips in such a way that the handle incisions are approximately 140 mm long and provided at even spacings at a distance from one another and in the same direction. In addition, the edges of the body layer 2 are provided with 120 mm folds on both sides to reinforce the durability of the handgrips in the base in carrying and drawing situations.

In the usage test, it was discovered that the protective material according to the invention works well both as an absorbent and as a protective material. In addition, the carrying capacity of the protective material was found to be good.

The protective materials described in the examples presented above are manufactured by a conventional layered structure manufacturing technique using devices and methods known per se in the art, which are not described in this connection in any more detail.

The protective and transfer material according to the invention is applicable for use as different embodiments in the most different applications.

The invention is not limited merely to the examples referred to above; instead, many variations are possible within the scope of the inventive idea defined by the claims.

1. A protective material, characterized in that the protective material is an elongated plate-type material, the protective material being in the form of a layered structure including at least a body layer with at least a core layer formed from a network-reinforced polymeric material, and at least one absorbent fiber-based layer provided to the upper surface of the body layer and at least partially connected to the upper surface of the body layer, and edge reinforcements which are provided to the longitudinal outer edges of the body layer in the protective material and connected to the upper surface of the body layer.

2. The protective material according to claim 1, wherein the edge reinforcement is formed from a woven material.

3. The protective material according to claim 1, wherein the network-reinforced polymeric material includes a network reinforcement layer and a polymeric film connected to one another to constitute the network-reinforced polymeric material.

4. The protective material according to claim 1, wherein the body layer includes a bottom layer provided under the core layer to reduce friction.

5. The protective material according to claim 1, wherein the bottom layer is formed from a nonwoven material.

6. The protective material according to claim 1, wherein the fiber-based layer is formed from a paper-based material.

7. The protective material according to claim 1, wherein the fiber-based layer is formed from air-laid paper.

8. The protective material according to claim 1, wherein the fiber-based layer includes an absorbent agent.

9. The protective material according to claim 1, wherein the protective material 1 includes at least two fiber-based layers.

10. The protective material according to claim 1, wherein the protective material includes a top layer which is provided to the upper surface of the fiber-based layer.

11. The protective material according to claim 1, wherein the protective material includes handgrips.

12. The protective material according to claim 11, wherein the handgrips are provided in connection with the edge reinforcements by making openings in the area of the edge reinforcement to provide the handgrips.

13. The protective material according to claim 1, wherein the fiber-based layer is fastened to the body layer by gluing, laminating and/or heat sealing.

14. The protective material according to claim 1, wherein the thickness of the protective material is less than 1.5 mm.

15. Use of a protective material according to claim 1, wherein the protective material is used in the applications of public healthcare, rescue services, transportation of patients and/or nursing institutions.

16. The use of a protective material according to claim 15, wherein the protective material is used as a cover for a base.
